(19) United States
(12) Patent Application Publication
(10) Pub. No.: US 2023/0090509 A1
(43) Pub. Date: Mar. 23, 2023

(54) DISPLAY APPARATUS, PHOTOELECTRIC CONVERSION APPARATUS, ELECTRONIC EQUIPMENT, AND MOBILE BODY

(71) Applicant: CANON KABUSHIKI KAISHA, Tokyo (JP)

(72) Inventor: Satoshi Kato, Kanagawa (JP)

(21) Appl. No.: 17/941,161

(22) Filed: Sep. 9, 2022

(30) Foreign Application Priority Data
Sep. 17, 2021 (JP) 2021-152428

(51) Int. Cl. G09G 3/3233

(52) U.S. Cl. CPC G09G 3/3233; G09G 2310/08; G09G 2300/0852; G09G 2300/0828; G09G 2330/021; G09G 2310/0291; G09G 2310/0289; G09G 2320/0233

(57) ABSTRACT

First substrate including display region having pixels and second substrate including driving circuit are stacked. Maximum voltage supplied to portion of the driving circuit arranged inside outer edge of the display region in plan view is lower than that supplied to the display region. The driving circuit includes processing circuit region. The outer edge of the display region is located inside outer edge of the processing circuit region in the plan view. Maximum voltage supplied to the processing circuit region is lower than that supplied to the display region. The maximum voltage supplied to the display region is power supply voltage supplied to first power supply terminal for the pixels. The maximum voltage supplied to the processing circuit region is power supply voltage supplied to second power supply terminal for the processing circuit region.

### BACKGROUND OF THE INVENTION

### Field of the Invention

The present technology relates to a display apparatus, a photoelectric conversion apparatus, an electronic equipment, and a mobile body.

### Description of the Related Art

Among recent display apparatuses represented by an organic EL display, when applied to applications such as a head mounted display, there is a tendency that a reduction in mounting area is demanded. One example of methods of implementing a reduction in mounting area is a method of stacking different semiconductor substrates.

Japanese Patent Laid-Open No. 2018-174246 discloses a display apparatus in which different semiconductor substrates are stacked. The display apparatus disclosed in Japanese Patent Laid-Open No. 2018-174246 has a structure in which a substrate with a light emitting element and a light receiving element provided therein and a substrate with a driving circuit provided therein are stacked.

However, in a structure in which a substrate including a display region formed from a plurality of light emitting elements and a substrate where a driving circuit is arranged are stacked, heat generated by the driving circuit can cause an uneven temperature distribution in the display region. Since the light emitting intensity of the light emitting element is dependent on temperature, the uneven temperature distribution in the display region can lead to an uneven light emission intensity distribution in the display region.

### SUMMARY OF THE INVENTION

The present invention has as its object to provide a technique advantageous in reducing an uneven light emission intensity distribution in a display region.

One of aspects of the present invention provides a display apparatus having a structure in which a first substrate including a display region where a plurality of pixels are arrayed and a second substrate including a driving circuit configured to drive the plurality of pixels are stacked, wherein a maximum voltage supplied to a portion of the driving circuit arranged inside an outer edge of the display region in an orthogonal projection with respect to a surface along the display region is lower than a maximum voltage supplied to the display region, the driving circuit includes a processing circuit region, and the outer edge of the display region is located inside an outer edge of the processing circuit region in the orthogonal projection with respect to the surface along the display region, a maximum voltage supplied to the processing circuit region is lower than the maximum voltage supplied to the display region, and the maximum voltage supplied to the display region is a power supply voltage supplied to a first power supply terminal configured to supply the power supply voltage to the plurality of pixels, and the maximum voltage supplied to the processing circuit region is a power supply voltage supplied to a second power supply terminal configured to supply the power supply voltage to the processing circuit region.

Further features of the present invention will become apparent from the following description of exemplary embodiments with reference to the attached drawings.

### BRIEF DESCRIPTION OF THE DRAWINGS

FIG. 1 is a view schematically showing the arrangement of a display apparatus according to the first embodiment;

FIG. 2 is a view illustrating the circuit arrangement of a pixel;

FIG. 3 is a view illustrating a planar view of the display apparatus according to the first embodiment;

FIG. 4 is a view schematically showing the arrangement of a display apparatus according to the second embodiment;

FIG. 5 is a view showing the arrangement of a signal supply circuit and register in the display apparatus according to the second embodiment;

FIG. 6 is a timing chart illustrating an operation of the display apparatus according to the second embodiment;

FIG. 7 is a view showing the arrangement of the signal supply circuit and the register in a modification of the display apparatus according to the second embodiment;

FIG. 8 is a timing chart illustrating an operation in the modification of the display apparatus according to the second embodiment;

FIG. 9 is a schematic view showing an example of a display apparatus according to an embodiment;

FIG. 10A is a schematic view showing an example of an image capturing apparatus according to an embodiment;

FIG. 10B is a schematic view showing an example of an electronic apparatus according to an embodiment;

FIG. 11A is a schematic view showing an example of a display apparatus according to an embodiment;

FIG. 11B is a schematic view showing an example of a foldable display apparatus;

FIG. 12A is a schematic view showing an example of an illumination apparatus according to an embodiment;

FIG. 12B is a schematic view showing an example of an automobile including a lighting unit for an automobile according to an embodiment; and

FIGS. 13A and 13B are views each showing an electronic apparatus according to an embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

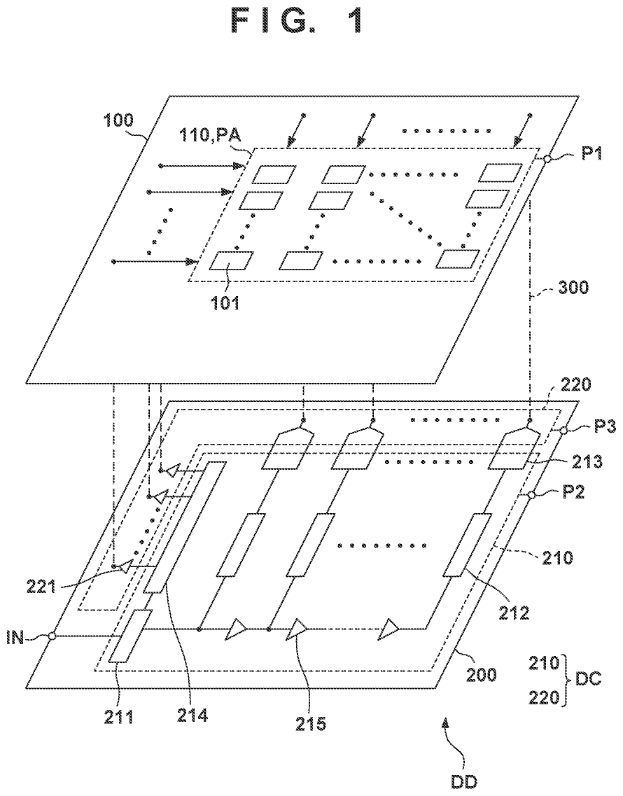

FIG. 1 schematically shows the arrangement of a display apparatus DD according to the first embodiment. The display apparatus DD can have a structure in which a first substrate 100 including a display region 110 or a pixel array PA where a plurality of pixels 101 are arrayed and a second substrate 200 including a driving circuit DC for driving the plurality of pixels 101 are stacked. The first substrate 100 and the second substrate 200 can be electrically connected via a plurality of electrical connection portions 300. In the first substrate 100, the plurality of pixels 101 can be arrayed so as to form a plurality of rows and a plurality of columns. The outer edge of the display region 110 in the first substrate 100 can form, for example, a minimum rectangular region that includes all of the plurality of pixels 101. The first substrate 100 can include a first power supply terminal P1. The display region 110 (or the plurality of pixels 101) can be supplied with a first power supply voltage which is supplied to the first power supply terminal P1.

In one aspect, the maximum voltage supplied to a portion of the driving circuit DC arranged inside the outer edge of the display region 110 in an orthogonal projection with respect to a surface along the display region 110 is lower than the maximum voltage supplied to the display region 110. The orthogonal projection with respect to the surface along the display region 110 can be, for example, an orthogonal projection with respect to a plane including the display region 110. The orthogonal projection with respect to the surface along the display region 110 can also be referred to as, for example, a plan view or a planar view.

The driving circuit DC in the second substrate 200 can include a processing circuit region 210 (a processing circuit from another point of view). The second substrate 200 can include a second power supply terminal P2. The processing circuit region 210 can be supplied with a second power supply voltage which is supplied to the second power supply terminal P2. In the orthogonal projection with respect to the surface along the display region 110, the outer edge of the display region 110 can be located inside the outer edge of the processing circuit region 210. The maximum voltage supplied to the processing circuit region 210 is lower than the maximum voltage supplied to the display region 110. The outer edge of the processing circuit region 210 can form a minimum rectangular or polygonal region that includes all of circuit elements arranged in the processing circuit region 210. From another point of view, the outer edge of the processing circuit region 210 can form a minimum rectangular or polygonal region that includes all of circuit elements to which a power supply voltage, which is lower than the first power supply voltage supplied to the first power supply terminal P1, is supplied.

The driving circuit DC in the second substrate 200 can include a relay circuit region 220 (a relay circuit from another point of view). In the orthogonal projection with respect to the surface along the display region 110, the relay circuit region 220 can be located outside the outer edge of the display region 110. The relay circuit region 220 can supply a signal corresponding to a signal generated in the processing circuit region 210 to the display region 110 (the pixel 101 in a selected row thereof).

The processing circuit region 210 can include a digital signal processor (DSP) 211 that generates, based on a signal supplied to an input terminal (for example, input pad) IN, a signal (digital signal) for controlling light emission of the plurality of pixels 101. The processing circuit region 210 can also include a plurality of registers 212 that temporarily store the signal (digital signal) output from the DSP 211. The number of the plurality of registers 212 can be the same as the number of the plurality of columns defined by the array of the plurality of pixels 101 forming the pixel array PA. Here, the processing circuit region 210 may include one or a plurality of buffers 215 between the signal (digital signal) output from the DSP 211 and the plurality of registers 212. The plurality of buffers 215 can be connected in a form of a repeat buffer.

The driving circuit DC can include a plurality of DA converters (DAC) 213 that convert a plurality of digital signals each output from each of the plurality of registers 212 into analog signals and supply the analog signals to a plurality of column signal lines of the pixel array PA. At least a part of each of the plurality of DA converters (DAC) 213 can be arranged in the relay circuit region 220. In addition to this, the relay circuit region 220 can include a level shift circuit 221 that supplies a signal, which is obtained by shifting the level of a signal generated by a vertical scanning unit 214 (to be described later), to the plurality of pixels 101. The remaining portion of each of the plurality of DA converters (DAC) 213 can be arranged in the processing circuit region 210. The second substrate 200 can include a third power supply terminal P3. The plurality of DA converters (DAC) 213 can be supplied with a third power supply voltage which is supplied to the third power supply terminal P3. For example, the third power supply voltage can have the same voltage value as the first power supply voltage. In one aspect, the maximum voltage supplied to the processing circuit region 210 is lower than the maximum voltage supplied to the relay circuit region 220.

The processing circuit region 210 can include the vertical scanning unit 214. The vertical scanning unit 214 can generate a plurality of control signals for the pixels 101 in each row to control the pixels 101 in the plurality of rows of the pixel array PA on a row basis. The plurality of control signals can include, for example, a row selection signal, a reset control signal, and a clamp control signal. The row selection signal, the reset control signal, and the clamp control signal can be level-converted by the level shift circuit 221 arranged in the relay circuit region 220, and supplied to the pixel array PA as a row selection signal SEL, a reset control signal RES, and a clamp control signal SW, respectively.

The processing circuit region 210 may include a circuit having another function such as, for example, an OTP (One Time Programmable)-ROM for storing correction data.

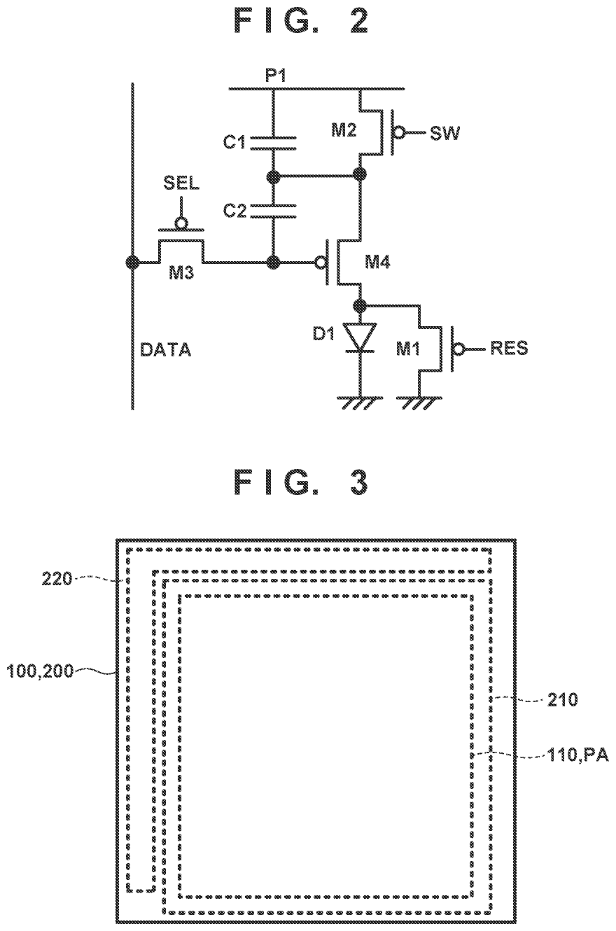

FIG. 2 shows an arrangement example of each pixel 101. Note that the arrangement example shown in FIG. 2 is merely an example, and the pixel 101 may have another arrangement. In the example shown in FIG. 2, each pixel 101 can include a light emitting element D1, a reset transistor M1, a capacitors C1 and C2, a switch transistor M2, a row selection transistor M3, and a driving transistor M4.

FIG. 3 illustrates the orthogonal projection of the first substrate 100 and the second substrate 200 with respect to a surface along the display region 110, or a planar view thereof. As illustrated in FIG. 3, in the orthogonal projection with respect to the surface along the display region 110 or the planar view, the outer edge of the display region 110 can be located inside the outer edge of the processing circuit region 210. As has been described above, in one aspect, the maximum voltage supplied to the portion of the driving circuit DC arranged inside the outer edge of the display region 110 in the orthogonal projection with respect to the surface along the display region 110 is lower than the maximum voltage supplied to the display region 110. In another aspect, the maximum voltage supplied to the processing circuit region 210 is lower than the maximum voltage supplied to the display region 110. The arrangement as described above is advantageous in reducing the power consumption of the driving circuit DC or the processing circuit region 210, which influences the temperature distribution in the display region 110, as compared to other arrangements. This is effective for reducing an uneven light emission intensity distribution in the display region 110 caused by heat generated by the driving circuit DC or the processing circuit region 210.

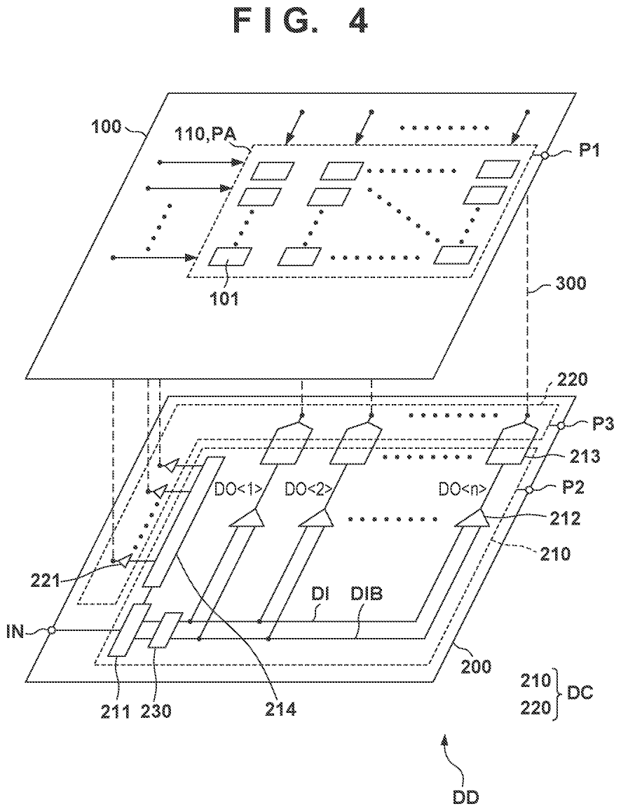

FIG. 4 schematically shows the arrangement of a display apparatus DD according to the second embodiment. Matters not mentioned as the second embodiment can follow the first embodiment. In the second embodiment, each of a plurality of registers 212 can include an amplification circuit, and a processing circuit region 210 can further include a signal supply circuit 230 that supplies signals, via a pair of signal lines DI and DIB, to the amplification circuit of each of the plurality of registers 212. The signal supply circuit 230 can generate a pair of differential signals having small amplitudes following a signal supplied from a DSP 211, and transmit the pair of differential signals to the amplification circuit of each of the plurality of registers 212. The pair of signal lines DI and DIB can be connected to the amplification circuit of each of the plurality of registers 212.

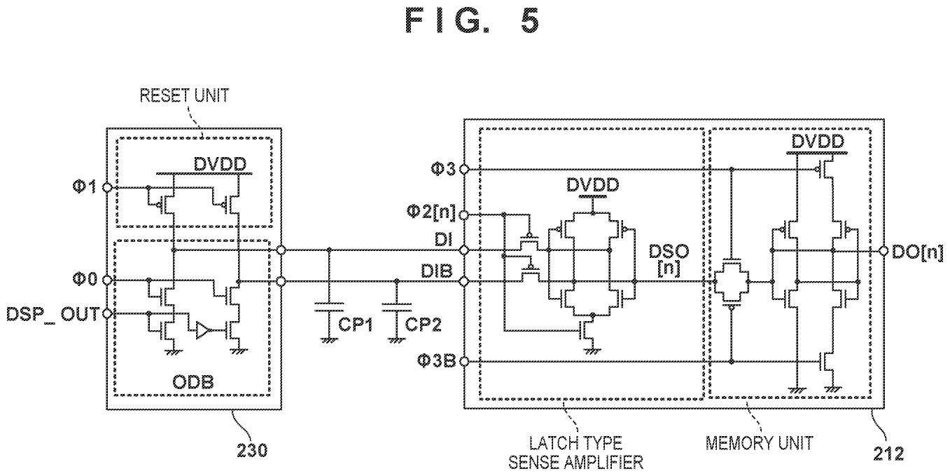

FIG. 5 shows an arrangement example of the signal supply circuit 230 and the register 212. Note that the signal supply circuit 230 is connected to the plurality of registers 212 via the pair of signal lines DI and DIB, but one register 212 alone, which outputs DO[n], is representatively shown in FIG. 5. The signal supply circuit 230 can include an open drain buffer (ODB) that is controlled by a pulse φ0 upon receiving DSP_OUT as an output of the DSP 211. The signal supply circuit 230 can also include a reset unit that is controlled by a pulse φ1 for resetting the voltage of the pair of signal lines DI and DIB to a digital power supply voltage DVDD. The register 212 can be formed from a latch type sense amplifier (to be simply referred to as a sense amplifier hereinafter) that is controlled by a pulse φ2[n], and a memory unit in which a write operation is controlled by a pulse φ3.

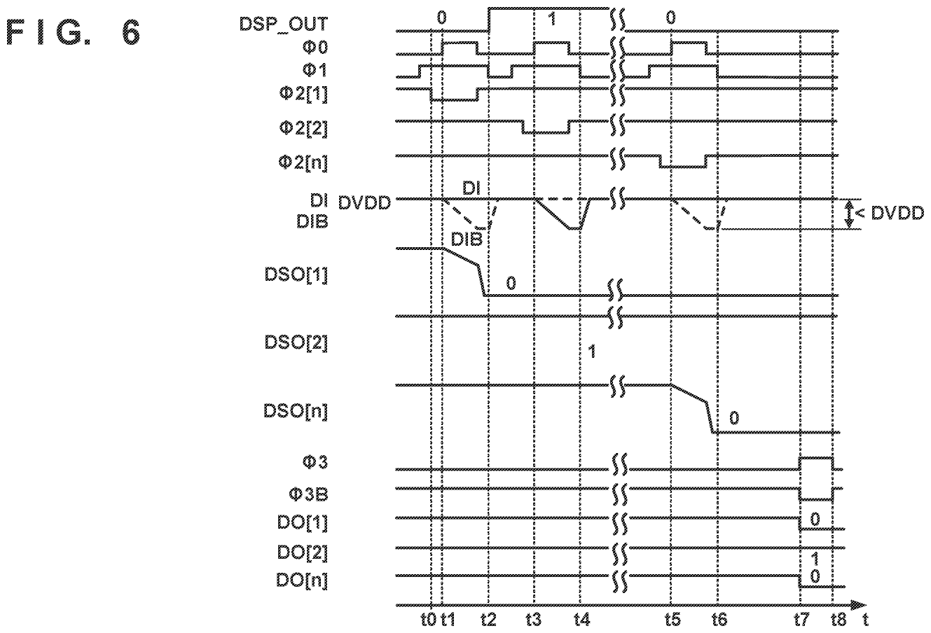

FIG. 6 illustrates a timing chart of the circuit illustrated in FIGS. 4 and 5. In FIG. 6, when φ2[1] is set at low level at time t0, the sense amplifier of the register 212 in the first row is set in a signal writing state. When φ0 is set at high level at time t1, since DSP_OUT is 0, the open drain buffer transistor for driving DI is turned off and the open drain buffer transistor for driving DIB is turned on. With this, electric charges held by a parasitic capacitance CP2 that is parasitic on DIB are extracted by a constant current corresponding to the size of the open drain buffer transistor. With this, the DIB potential decreases and, when φ0 is set at low level and φ2[1] is set at high level, signal writing is complete. At the same time, the sense amplifier is set in an amplification mode, and amplifies the signal to the amplitude level equivalent to DVDD in accordance with the differential amplitude between DI and DIB, thereby setting the level of DSO[1] to 0.

At time t2, φ1 is set at low level, DI and DIB are reset to DVDD by the reset unit of the signal supply circuit 230, and a signal for writing in the resistor 212 in the second row is output from the DSP 211 to DSP_OUT.

When φ0 is set at high level at time t3, since DSP_OUT is 1, the open drain buffer transistor for driving DI is turned on and the open drain buffer transistor for driving DIB is turned off to start discharge of electric charges held in the parasitic capacitance CP1. With this, the DI potential decreases. As in the case of the first row, when φ0 is set at low level and φ2[2] is set at high level, signal writing is complete. In addition, the sense amplifier is set in the amplification mode, and the level of DSO[2] is set to 1. At time t4, DI and DIB are reset.

In the manner as described above, the signal writing operation from the DSP 211 to the plurality of registers 212 is sequentially performed. This operation is complete when signal writing in the nth row is performed and the amplification processing by the sense amplifier is performed during a period from time t5 to time t6. Then, when φ3 is set at high level during a period from time t7 to time t8, the signals in all the rows are collectively transmitted to the memory in the next stage. The DAC 213 converts a signal DO[n:1] held in the memory unit of the register 212 into an analog signal DATA.

In the operation described above, signal transmission from the DSP 211 to the plurality of registers 212 is implemented by the open drain buffer of the signal supply circuit 230 and the sense amplifier of the register 212 using constant current driving and accompanying small amplitude driving. Thus, as compared to the arrangement illustrated in FIG. 1, that is, the arrangement in which signal transmission from the DSP 211 to the plurality of registers 212 is performed while performing buffering by a repeat buffer or the like, power consumption and heat generation can be suppressed. Therefore, it is possible to suppress an uneven temperature distribution in the display region 110 caused by the signal transmission, and an accompanying uneven light emission intensity distribution.

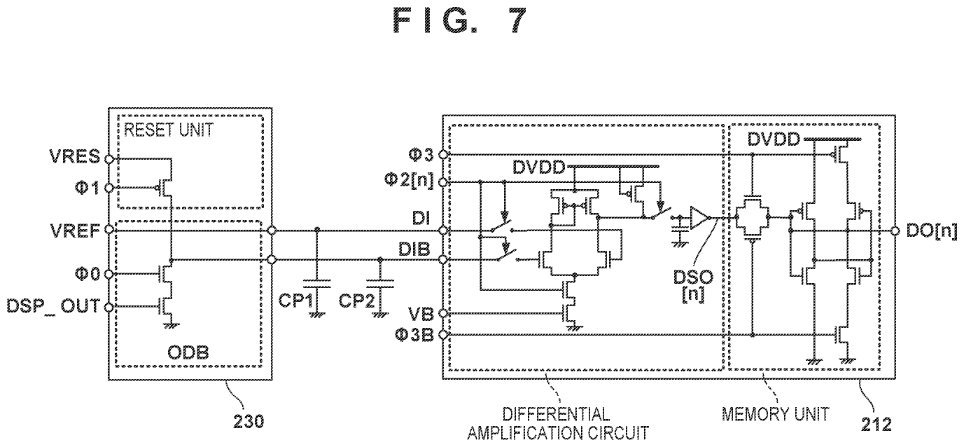

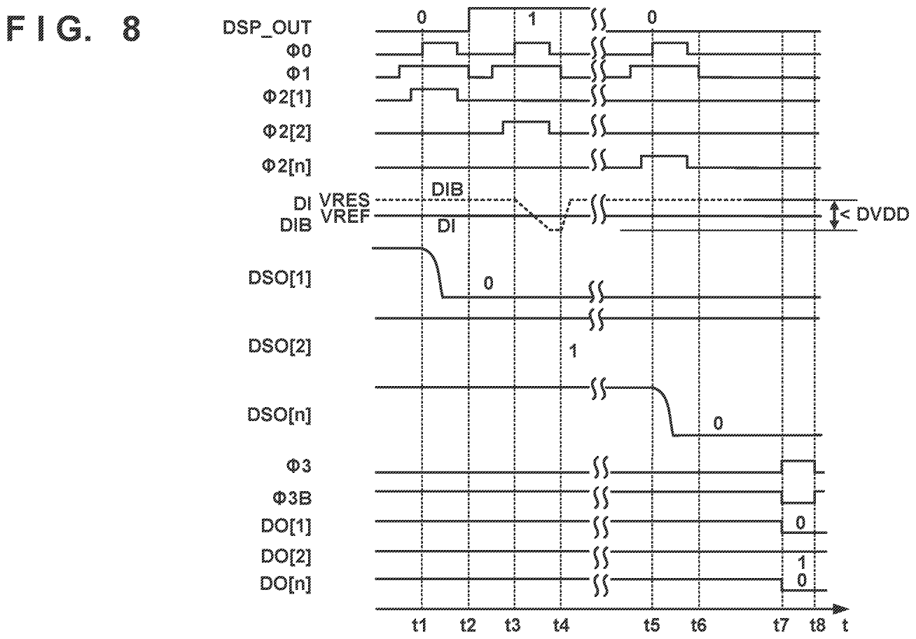

FIG. 7 shows a modification of the circuit shown in FIG. 5. FIG. 8 is a timing chart of an arrangement example shown in FIG. 7. In the circuit shown in FIG. 7, the latch type sense amplifier in the circuit shown in FIG. 5 is replaced with a differential amplification circuit. The circuit shown in FIG. 7 is basically the same as the circuit shown in FIG. 5, but different from the circuit shown in FIG. 5 in that DI is fixed to a reference potential VREF and VRES is used as the reset potential of DIB. The DI potential fixed to the reference potential VREF is compared with the DIB potential which is an output of the open drain buffer upon receiving DSP_OUT. When the magnitude relationship therebetween is reversed, an output of the differential amplification circuit is reversed. So as not to generate excessive power, the differential amplification circuit itself is powered off except when signal writing is performed based on φ2[n:1]. In this manner, the amplifier of each register 212 may be implemented by a component other than the sense amplifier.

Alternatively, for example, in the register 212 in the circuit shown in FIG. 5, a circuit similar to the signal supply circuit 230 may be provided in the output portion of the latch type sense amplifier such that the circuit of the memory unit also becomes a latch type sense amplifier. With this, it is also possible to suppress current fluctuation which occurs during collective transmission of signals in all the rows from the latch type sense amplifier to the memory unit, which is controlled by φ3 shown in FIG. 6. When current fluctuation during collective transmission of the signals in all the rows is suppressed, a voltage fluctuation amount of DVDD can also be suppressed. This is advantageous in reducing the voltage of DVDD. In addition, since the number of data that can be simultaneously transmitted in signal transmission increases, the signal transmission time can be shortened, and this is also advantageous from a point of view of increasing the speed.

Application examples of the display apparatus described above will be described below.

FIG. 9 is a schematic view showing an example of a display apparatus according to an embodiment. A display apparatus 1000 may include a touch panel 1003, a display panel 1005, a frame 1006, a circuit board 1007, and a battery 1008 between an upper cover 1001 and a lower cover 1009. The representative display apparatus DD according to the above-described embodiment can be applied as the display panel 1005. Flexible printed circuits (FPCs) 1002 and 1004 are respectively connected to the touch panel 1003 and the display panel 1005. Transistors are printed on the circuit board 1007. The battery 1008 is unnecessary if the display apparatus is not a portable equipment. Even when the display apparatus is a portable equipment, the battery 1008 may be arranged at another position.

The display apparatus according to this embodiment may include color filters of red, green, and blue. The color filters of red, green, and blue may be arranged in a delta array.

The display apparatus according to this embodiment may also be used for a display unit of a portable terminal. At this time, the display unit may have both a display function and an operation function. Examples of the portable terminal are a portable phone such as a smartphone, a tablet, and a head mounted display.

The display apparatus according to this embodiment may be used for a display unit of an image capturing apparatus including an optical unit including a plurality of lenses, and an image sensor for receiving light having passed through the optical unit. The image capturing apparatus may include a display unit for displaying information acquired by the image sensor. In addition, the display unit may be either a display unit exposed outside the image capturing apparatus, or a display unit arranged in the finder. The image capturing apparatus may be a digital camera or a digital video camera.

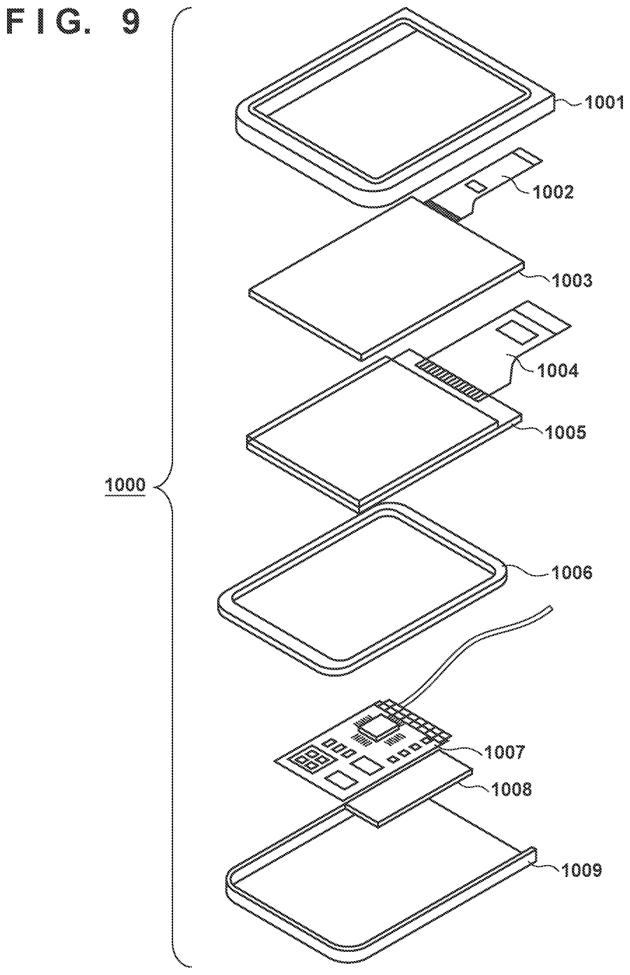

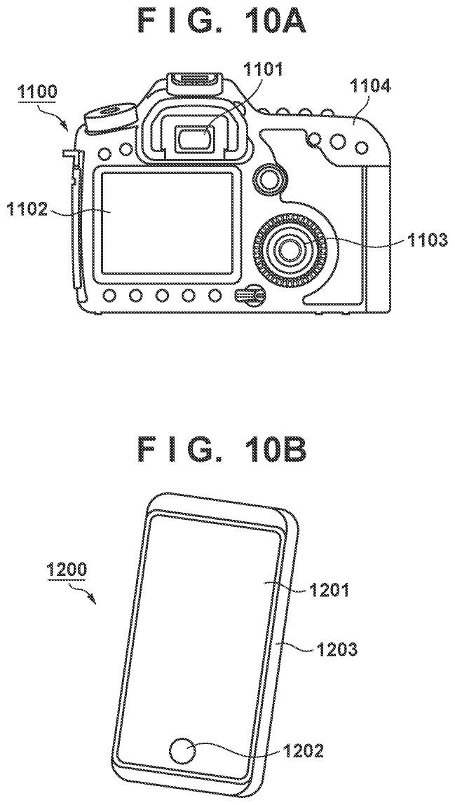

FIG. 10A is a schematic view showing an example of an image capturing apparatus according to an embodiment. An image capturing apparatus 1100 may include a viewfinder 1101, a rear display 1102, an operation unit 1103, and a housing 1104. The representative display apparatus DD according to the above-described embodiment can be applied as the viewfinder 1101. In this case, the display apparatus may display not only an image to be captured but also environment information, image capturing instructions, and the like. Examples of the environment information may be the intensity and direction of external light, the moving velocity of an object, and the possibility that an object is covered with an obstacle.

The timing suitable for image capturing is a very short time, so the information is preferably displayed as soon as possible. Therefore, the display apparatus using the organic light emitting element of the present invention is preferably used. This is so because the organic light emitting element has a high response speed. The display apparatus using the organic light emitting element can be used for the apparatuses that require a high display speed more preferably than for the liquid crystal display apparatus.

The image capturing apparatus 1100 includes an optical unit (not shown). This optical unit includes a plurality of lenses, and forms an image on an image sensor that is accommodated in the housing 1104. The focal points of the plurality of lenses can be adjusted by adjusting the relative positions. This operation can also automatically be performed. The image capturing apparatus may be called a photoelectric conversion apparatus. Instead of sequentially capturing an image, the photoelectric conversion apparatus can include, as an image capturing method, a method of detecting the difference from a previous image, a method of extracting an image from an always recorded image, or the like.

FIG. 10B is a schematic view showing an example of an electronic equipment according to an embodiment. An electronic equipment 1200 includes a display unit 1201, an operation unit 1202, and a housing 1203. The housing 1203 can accommodate a circuit, a printed board having this circuit, a battery, and a communication unit. The representative display apparatus DD according to the above-described embodiment can be applied as the display unit 1201. The operation unit 1202 may be a button or a touch-panel-type reaction unit. The operation unit may also be a biometric authentication unit that performs unlocking or the like by authenticating the fingerprint. The electronic equipment including the communication unit can also be regarded as a communication equipment. The electronic equipment can further have a camera function by including a lens and an image sensor. An image captured by the camera function is displayed on the display unit. Examples of the electronic equipment are a smartphone and a notebook computer.

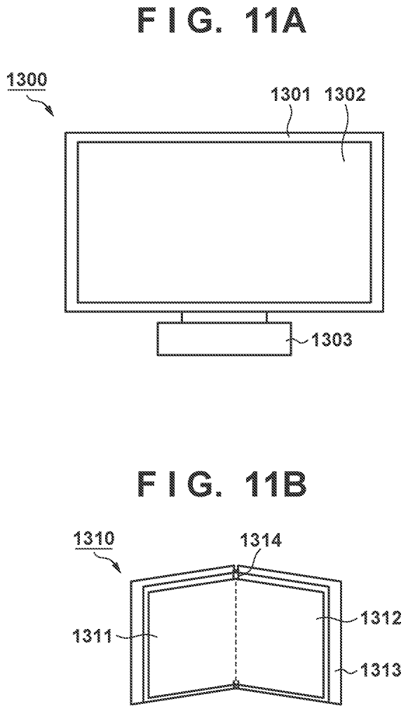

FIG. 11A is a schematic view showing an example of a display apparatus according to an embodiment. The representative display apparatus DD according to the above-described embodiment can be embodied as a display apparatus 1300 such as a television monitor or a PC monitor. The display apparatus 1300 includes a frame 1301 and a display unit 1302. The light emitting apparatus according to this embodiment can be used for the display unit 1302.

The display apparatus 1300 includes a base 1303 that supports the frame 1301 and the display unit 1302. The base 1303 is not limited to the form shown in FIG. 11A. The lower side of the frame 1301 may also function as the base.

In addition, the frame 1301 and the display unit 1302 may be bent. The radius of curvature in this case may be 5,000 (inclusive) mm to 6,000 (inclusive) mm.

FIG. 11B is a schematic view showing another example of the display apparatus according to this embodiment. The representative display apparatus DD according to the above-described embodiment can be embodied as a foldable display apparatus 1310. The display apparatus 1310 is a so-called foldable display apparatus. The display apparatus 1310 includes a first display unit 1311, a second display unit 1312, a housing 1313, and a bending point 1314. Each of the first display unit 1311 and the second display unit 1312 can employ the representative display apparatus DD according to the above-described embodiment. The light emitting apparatus according to this embodiment may be included. The first display unit 1311 and the second display unit 1312 may be one seamless display apparatus. The first display unit 1311 and the second display unit 1312 can be divided by the bending point. The first display unit 1311 and the second display unit 1312 may display different images, and may also display one image together.

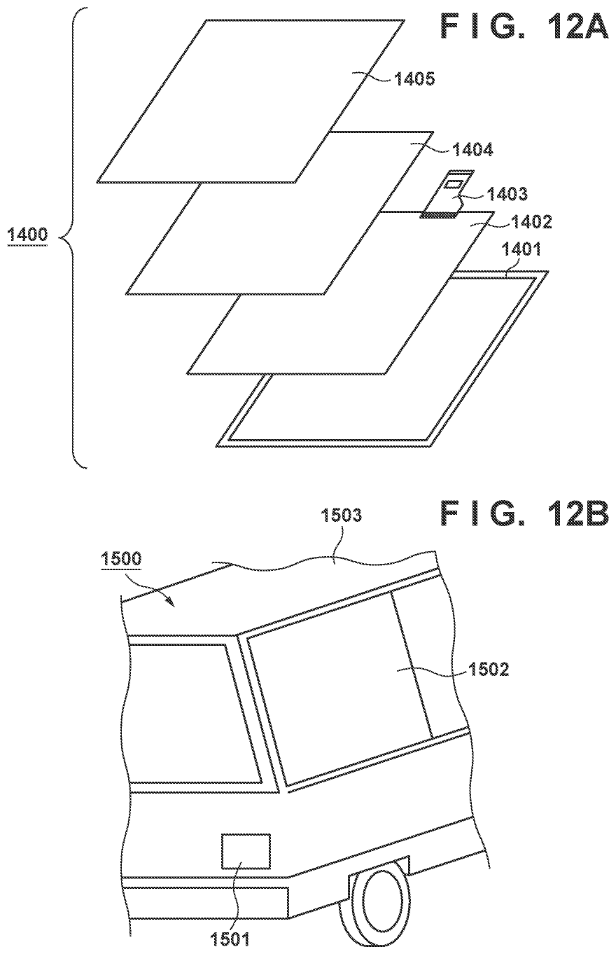

FIG. 12A is a schematic view showing an example of an illumination apparatus according to an embodiment. An illumination apparatus 1400 may include a housing 1401, a light source 1402, a circuit board 1403, an optical film 1404, and a light-diffusing unit 1405. The representative display apparatus DD according to the above-described embodiment can be applied as the light source. The optical filter may be a filter that improves the color rendering of the light source. When performing lighting-up or the like, the light-diffusing unit can throw the light of the light source over a broad range by effectively diffusing the light. The optical filter and the light-diffusing unit can be provided on the illumination light emission side.

The illumination apparatus may also include a cover on the outermost portion, as needed.

The illumination apparatus is, for example, an apparatus for illuminating the interior of the room. The illumination apparatus may emit white light, natural white light, or light of any color from blue to red. The illumination apparatus may include a light control circuit for controlling these light components.

The illumination apparatus may include the organic light emitting element according to the present invention and a power supply circuit connected to the organic light emitting element. The power supply circuit is a circuit for converting an AC voltage into a DC voltage. White has a color temperature of 4,200 K, and natural white has a color temperature of 5,000 K. The illumination apparatus may include a color filter.

In addition, the illumination apparatus according to this embodiment may include a heat radiation unit. The heat radiation unit radiates the internal heat of the apparatus to the outside of the apparatus, and examples are a metal having a high specific heat and liquid silicon.

FIG. 12B is a schematic view of an automobile as an example of a moving body according to an embodiment. The automobile includes a taillight as an example of the lighting appliance. An automobile 1500 includes a taillight 1501, and may have a form in which the taillight is turned on when performing a braking operation or the like.

The representative display apparatus DD according to the above-described embodiment can be applied as the taillight 1501. The taillight may include a protection member for protecting the organic EL element. The material of the protection member is not limited as long as the material is a transparent material with a strength that is high to some extent, and is preferably polycarbonate. A furandicarboxylic acid derivative, an acrylonitrile derivative, or the like may be mixed in polycarbonate.

The automobile 1500 may include a vehicle body 1503, and a window 1502 attached to the vehicle body 1503. This window may be a window for checking the front and back of the automobile, or may be a transparent display. This transparent display may include the organic light emitting element according to this embodiment. In this case, the constituent materials of the electrodes and the like of the organic light emitting element are formed by transparent members.

The moving body according to this embodiment may be a ship, an airplane, a drone, or the like. The moving body may include a main body and a lighting appliance installed in the main body. The lighting appliance may emit light for making a notification of the position of the main body. The lighting appliance includes the organic light emitting element according to this embodiment.

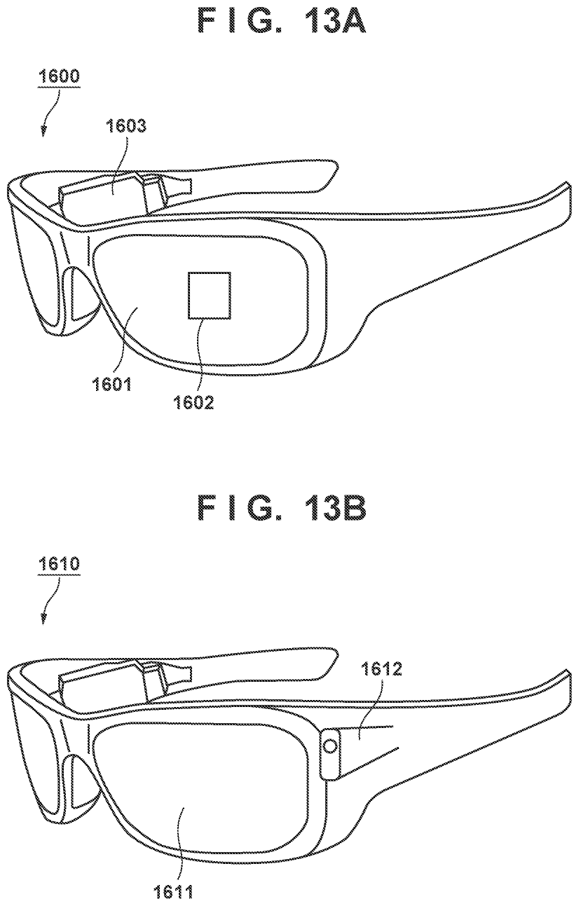

With reference to FIGS. 13A and 13B, application examples of the display apparatus according to each of the above-described embodiments will be described. The display apparatus can be applied to a system that can be worn as a wearable device such as smartglasses, an HMD, or a smart contact lens. An image capturing display apparatus used for such application examples can include an image capturing apparatus capable of photoelectrically converting visible light and a display apparatus capable of emitting visible light.

Glasses 1600 (smartglasses) according to one application example will be described with reference to FIG. 13A. An image capturing apparatus 1602 such as a CMOS sensor or an SPAD is provided on the surface side of a lens 1601 of the glasses 1600. In addition, the display apparatus of each of the above-described embodiments is provided on the back surface side of the lens 1601.

The glasses 1600 further includes a control apparatus 1603. The control apparatus 1603 functions as a power supply that supplies power to the image capturing apparatus 1602 and the display apparatus according to each embodiment. In addition, the control apparatus 1603 controls the operations of the image capturing apparatus 1602 and the display apparatus. An optical system configured to condense light to the image capturing apparatus 1602 is formed on the lens 1601.

Glasses 1610 (smartglasses) according to one application example will be described with reference to FIG. 13B. The glasses 1610 includes a control apparatus 1612, and an image capturing apparatus corresponding to the image capturing apparatus 1602 and a display apparatus are mounted on the control apparatus 1612. The image capturing apparatus in the control apparatus 1612 and an optical system configured to project light emitted from the display apparatus are formed in a lens 1611, and an image is projected to the lens 1611. The control apparatus 1612 functions as a power supply that supplies power to the image capturing apparatus and the display apparatus, and controls the operations of the image capturing apparatus and the display apparatus. The control apparatus may include a line-of-sight detection unit that detects the line of sight of a wearer. The detection of a line of sight may be done using infrared rays. An infrared ray emitting unit emits infrared rays to an eyeball of the user who is gazing at a displayed image. An image capturing unit including a light receiving element detects reflected light of the emitted infrared rays from the eyeball, thereby obtaining a captured image of the eyeball. Image quality degradation is reduced by providing a reduction means that reduces the light from the infrared light emitting unit to the display unit in a planar view.

The line of sight of the user to the displayed image is detected from the captured image of the eyeball obtained by capturing the infrared rays. An arbitrary known method can be applied to the line-of-sight detection using the captured image of the eyeball. As an example, a line-of-sight detection method based on a Purkinje image obtained by reflection of irradiation light by a cornea can be used.

More specifically, line-of-sight detection processing based on pupil center corneal reflection is performed. Using pupil center corneal reflection, a line-of-sight vector representing the direction (rotation angle) of the eyeball is calculated based on the image of the pupil and the Purkinje image included in the captured image of the eyeball, thereby detecting the line-of-sight of the user.

The display apparatus according to an embodiment of the present invention may include an image capturing apparatus including a light receiving element, and a displayed image on the display apparatus may be controlled based on the line-of-sight information of the user from the image capturing apparatus.

More specifically, in the display apparatus, a first field-of-view region which is gazed at by the user and a second field-of-view region other than the first field-of-view region are determined based on the line-of-sight information. The first field-of-view region and the second field-of-view region may be determined by a control apparatus of the display apparatus. Alternatively, the first field-of-view region and the second field-of-view region may be determined by an external control apparatus and the display apparatus may receive information corresponding to this determination. Control can be performed in the display region of the display apparatus so that the display resolution of the first field-of-view region will be higher than the display resolution of the second field-of-view region. That is, the resolution of the second field-of-view region may be lowered more than the resolution of the first field-of-view region.

In addition, the display region includes a first display region and a second display region different from the first display region, and a region with a high degree of priority is determined from the first display region and the second display region of the display region based on the line-of-sight information. The first field-of-view region and the second field-of-view region may be determined by the control apparatus of the display apparatus. Alternatively, the first field-of-view region and the second field-of-view region may be determined by an external control apparatus and the display apparatus may receive information corresponding to this determination. Control may be performed so that the resolution of a region with the high degree of priority will be set higher than the resolution of a region other than the region with the high degree of priority. That is, the resolution of a region with a relatively low degree of priority may be set low.

Note that an AI may be used for the determination of the first field-of-view region and the region with the high degree of priority. The AI may be a model configured to estimate, from an image of the eyeball, the angle of the line of sight and the distance to an object as the target of the gaze by using the image of the eyeball and the actual direction of the gaze of the eyeball of the image as the teaching data. The display apparatus, the image capturing apparatus, or an external apparatus may include the AI program. If the AI program is included in an external apparatus, information determined by the AI program will be transmitted to the display apparatus by communication.

When performing display control based on line-of-sight detection, smartglasses further including an image capturing apparatus configured to capture the outside can preferably be applied. The smartglasses can display captured outside information in real time.

As has been described above, when an apparatus using the organic light emitting element according to this embodiment is used, stable display with high image quality can be performed even in long time display.

According to the present invention, a technique advantageous in reducing an uneven light emission intensity distribution in a display region is provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-152428, filed Sep. 17, 2021, which is hereby incorporated by reference herein in its entirety.

### EXPLANATION OF REFERENCE SIGNS

100: first substrate, 101: pixel, 110: display region, PA: pixel array, 200: second substrate, 210: processing circuit region, 220: relay circuit region, DC: driving circuit

What is claimed is:

1. A display apparatus having a structure in which a first substrate including a display region where a plurality of pixels are arrayed and a second substrate including a driving circuit configured to drive the plurality of pixels are stacked, wherein
a maximum voltage supplied to a portion of the driving circuit arranged inside an outer edge of the display region in an orthogonal projection with respect to a surface along the display region is lower than a maximum voltage supplied to the display region,
the driving circuit includes a processing circuit region, and the outer edge of the display region is located inside an outer edge of the processing circuit region in the orthogonal projection with respect to the surface along the display region,
a maximum voltage supplied to the processing circuit region is lower than the maximum voltage supplied to the display region, and
the maximum voltage supplied to the display region is a power supply voltage supplied to a first power supply terminal configured to supply the power supply voltage to the plurality of pixels, and the maximum voltage supplied to the processing circuit region is a power supply voltage supplied to a second power supply terminal configured to supply the power supply voltage to the processing circuit region.

2. The apparatus according to claim 1, wherein
the driving circuit includes a relay circuit region configured to supply a signal corresponding to a signal generated in the processing circuit region to the display region, and the relay circuit region is located outside the outer edge of the display region in the orthogonal projection, and
the maximum voltage supplied to the processing circuit region is lower than a maximum voltage supplied to the relay circuit region.

3. The apparatus according to claim 2, wherein
the maximum voltage supplied to the relay circuit region is a power supply voltage supplied to a third power supply terminal configured to supply the power supply voltage to the relay circuit region.

4. The apparatus according to claim 3, wherein
a plurality of column signal lines are arranged in the display region,
the processing circuit region includes a plurality of registers configured to store a plurality of digital signals for controlling light emission of the plurality of pixels, and
the relay circuit region includes at least a part of each of a plurality of DA converters configured to convert a plurality of digital signals output from the plurality of registers, respectively, into analog signals and supply the analog signals to the plurality of column signal lines.

5. The apparatus according to claim 4, wherein
each of the plurality of registers includes an amplification circuit.

6. The apparatus according to claim 5, wherein
the amplification circuit is a latch type sense amplifier.

7. The apparatus according to claim 5, wherein
the amplification circuit includes a differential amplification circuit.

8. The apparatus according to claim 6, wherein
the processing circuit region further includes a signal supply circuit configured to supply signals, via a pair of signal lines, to the amplification circuits of the plurality of registers.

9. The apparatus according to claim 8, wherein
the signal supply circuit includes an open drain buffer.

10. The apparatus according to claim 4, wherein
the processing circuit region includes a digital signal processor configured to generate a signal to be supplied to the plurality of registers.

11. The apparatus according to claim 2, wherein
the processing circuit region includes a vertical scanning unit, and
the relay circuit region includes a level shift circuit configured to supply a signal, which is obtained by shifting a level of a signal generated by the vertical scanning circuit, to the plurality of pixels.

12. A display apparatus having a structure in which a first substrate including a display region where a plurality of pixels are arrayed and a second substrate including a driving circuit configured to drive the plurality of pixels are stacked, wherein
a plurality of column signal lines are arranged in the display region, and
the driving circuit includes a plurality of processing circuits configured to generate a plurality of digital signals for controlling light emission of the plurality of pixels, and each of the plurality of processing circuits includes an amplification circuit.

13. The apparatus according to claim 12, wherein
the amplification circuit is a latch type sense amplifier.

14. The apparatus according to claim 12, wherein
the amplification circuit includes a differential amplification circuit.

15. The apparatus according to claim 12, wherein
the driving circuit further includes a signal supply circuit configured to supply signals, via a pair of signal lines, to the amplification circuit of each of the plurality of processing circuits.

16. The apparatus according to claim 15, wherein
the signal supply circuit includes an open drain buffer.

17. The apparatus according to claim 15, wherein
the driving circuit includes a digital signal processor configured to generates a signal to be supplied to the signal supply circuit.

18. A photoelectric conversion apparatus comprising:
an optical unit including a plurality of lenses;
an image sensor configured to receive light having passed through the optical unit; and
a display unit configured to display an image captured by the image sensor,
wherein the display unit includes a display apparatus defined in claim 1.

19. An electronic equipment comprising:
a display apparatus defined in claim 1;
a housing provided with the display apparatus; and
a communication unit provided in the housing and configured to perform external communication.

20. A mobile body comprising:
an image capturing unit configured to capture an object; and
a display apparatus defined in claim 1 configured to display an image based on data from the image capturing unit.
